(19) United States
(12) Patent Application Publication
(10) Pub. No.: US 2024/0141724 A1
(43) Pub. Date: May 2, 2024

(54) VENETIAN BLIND

(71) Applicant: UNION WINNER INTERNATIONAL CO., LTD., TAIPEI CITY (TW)

(72) Inventor: Ming-Tsung PAI, CAOTUN TOWNSHIP (TW)

(73) Assignee: UNION WINNER INTERNATIONAL CO., LTD., TAIPEI CITY (TW)

(21) Appl. No.: 18/410,775

(22) Filed: Jan. 11, 2024

Related U.S. Application Data
(63) Continuation-in-part of application No. 18/336,628, filed on Jun. 16, 2023.
Application No. 18/336,628 is a continuation-in-part of application No. 16/589,628, filed on Oct. 1, 2019, now Pat. No. 11,873,681.

(51) Int. Cl. E06B 9/384; E06B 9/303; E06B 9/382; E06B 9/386

(52) U.S. Cl. CPC E06B 9/384; E06B 9/303; E06B 9/382; E06B 9/386

(57) ABSTRACT

A venetian blind includes an upper beam, a lower beam, and multiple slats arranged between the upper and lower beams and each having a through hole and a slot communicating with the through hole. Two ladder tapes link the upper and lower beams and each have a first warp, a second warp, a plurality of wefts connected between the first and second warps and supporting the slats. One of the ladder tapes has a plurality of second ring portions passing through the through holes through the slots. A first lifting cord is provided adjacent to the first warp of one of the ladder tapes, and a second lifting cord is provided adjacent to the second warp of one of the ladder tapes and passes through the second ring portions of one of the ladder tapes. As such, the present invention is structurally simple and easy to be assembled.

### BACKGROUND OF THE INVENTION

### 1. Field of the Invention

The present invention relates to venetian blinds and more particularly, to a venetian blind that is structurally simple and easy to be assembled.

### 2. Description of the Related Art

U.S. Pat. No. 7,556,080B2 discloses a window blind that has a plurality of connectors. Each of the connectors passes through the holes formed on the slats from above. Each of the connectors has a first end connected to the rear vertical portion of the ladder, and each of the connectors has a second end formed with a loop portion for a lifting cord to pass therethrough, so that the lifting cord can only be moved vertically but not transversely. In addition, after passing through the holes of the slats, the second end of the connector can be provided with a stopper formed by a metal sheet or a knot to prevent the connector from slipping off the slats.

In the prior patent, however, although the connector is flexible, the small hole diameter makes it time-consuming to pass the connector through the hole from above. Further, after the time-consuming threading operation, there is an additional step to use the metal sheet to hold the second end of the connector or to knot the second end of the connector, making the overall assembling work more difficult. Once any of the assembled slats gets damaged and needs to be replaced, it is necessary to detach the metal sheet or unknot the second end before taking further maintenance or repair actions. Hence, the prior patent is inconvenient in terms of assembling, and improvement is therefore desirable.

### SUMMARY OF THE INVENTION

It is a primary objective of the present invention to provide a venetian blind that is structurally simple and easy to be assembled, in which its slats are prevented from excessive transverse displacement.

To attain the above objective, the venetian blind of the present invention comprises an upper beam, a lower beam, a plurality of slats, two ladder tapes, and a lifting cord assembly. The lower beam is located below the upper beam. The slats are arranged between the upper and lower beams Each of the slats has one end thereof provided with a through hole and a slot passing through the top and bottom surfaces of the slat and communicating with the through hole. The ladder tapes are connected between the upper and lower beams and each have a first warp, and a second warp opposite to the first warp, and a plurality of wefts connected between the first and second warps and supporting the bottom surfaces of the slats. Further, one of the ladder tapes has a plurality of second ring portions passing through the through holes through the slots. The lifting cord assembly includes a first lifting cord arranged adjacent to the first warp of one of the ladder tapes, and a second lifting cord arranged adjacent to the second warp of one of the ladder tapes and passing through the second ring portions of one of the ladder tapes.

It can be seen from the above that through the through holes and the slots of the slats, the venetian blind of the present invention allows the ladder tapes to be assembled with the slats conveniently and firmly without using other tools: meanwhile, the damaged slats are easily disassembled from the ladder tapes for repair or replacement. Further, the venetian blind of the present invention prevents the slats from excessive transverse displacement through the ring portions and the through holes, such that the slats 40 can be aligned automatically.

Preferably, the ladder tape with the second ring portions further includes a plurality of a first ring portions connected with the first warp. The first lifting cord passes through the first ring portions.

Preferably, the venetian blind further comprising two said lifting cord assemblies. The second lifting cord of one of the lifting cord assemblies passes through the second ring portions of one of the ladder tapes.

Preferably, the other of the ladder tapes further includes a plurality of first ring portions connected with the first warp. The first lifting cord of the other of the lifting cord assemblies passes through the first ring portions of the other of the ladder tapes.

Preferably, each of the slats has two ends thereof each provided with the slot and the through hole. The venetian blind further comprises two said lifting cord assemblies. The other of the ladder tapes includes a plurality of the second ring portions. The second lifting cords of the lifting cord assemblies pass through the second ring portions of the ladder tapes.

Preferably, the ladder tapes each have a plurality of first ring portions connected with the first warp. The venetian blind further comprises two said lifting cord assemblies. The first lifting cords pass through the first ring portions and the second lifting cords pass through the second ring portions.

Preferably, the slot has a first extending segment extending from a second edge of the slat in a width direction of the slat to a first edge of the slat, and a second extending segment extending from one end of the first extending segment in a length direction of the slat to the through hole. The through hole passes through the top and bottom surfaces of the slat and is located between the second edge of the slat and the second extending segment of the slot.

Preferably, the second extending segment is perpendicular to the first extending segment.

Preferably, the slot extends inclinedly from a second edge of the slat to a first edge of the slat.

Preferably, the second ring portion has an upper segment fixed to the second warp at a first position above the wefts and a lower segment fixed to the second warp at a second position spaced apart from the first position and above the wefts when the slats are in an open state and perpendicular to the second warps.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a venetian blind of a first embodiment of the present invention.

FIG. 2 is an enlarged view of part A of FIG. 1.

FIG. 3 is an enlarged view of the slat, showing that the slot extends in an inclined manner.

FIG. 4 is a perspective view of the venetian blind of a second embodiment of the present invention.

FIG. 5 is an enlarged view of part A of FIG. 4.

FIG. 6 is an enlarged view of part B of FIG. 4.

FIG. 7 is a perspective view of the venetian blind of a third embodiment of the present invention.

FIG. 8 is an enlarged view of part A of FIG. 7.

FIG. 9 is an enlarged view of part B of FIG. 7.

FIG. 10 is a perspective view of the venetian blind of a fourth embodiment of the present invention.

FIG. 11 is an enlarged view of part A of FIG. 10.

FIG. 12 is an enlarged view of part B of FIG. 10.

FIG. 13 is a perspective view of the venetian blind of a fifth embodiment of the present invention.

FIG. 14 is an enlarged view of part A of FIG. 13.

FIG. 15 is an enlarged view of part B of FIG. 13.

FIG. 16 is a perspective view of a venetian blind of a sixth embodiment of the present invention.

FIG. 17 is an enlarged view of part A of FIG. 16.

FIG. 18 is an enlarged view of part B of FIG. 16

FIG. 19 is an enlarged view of part C of FIG. 16.

### DETAILED DESCRIPTION OF THE INVENTION

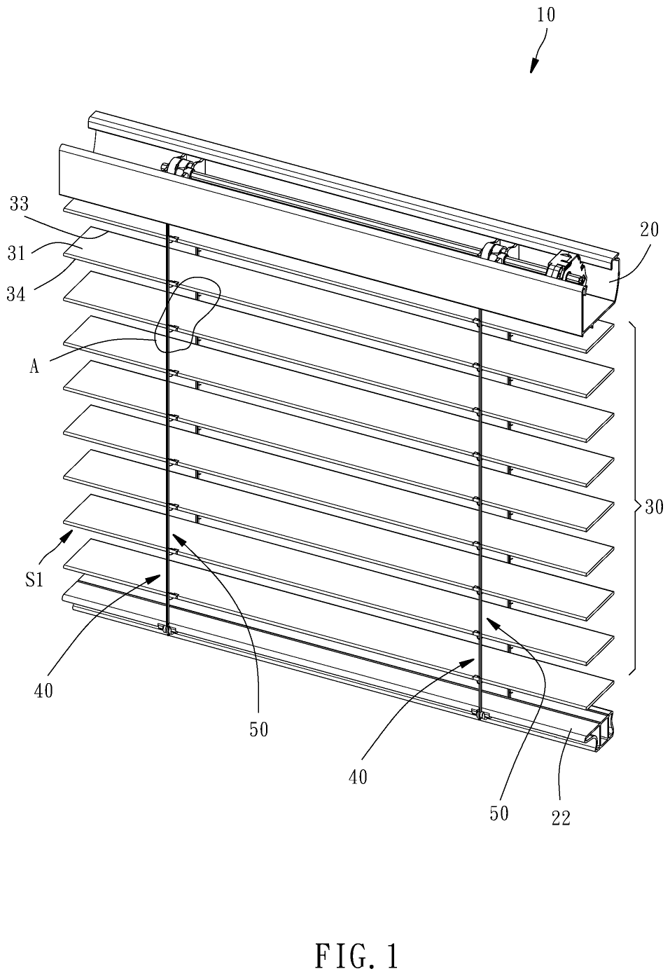

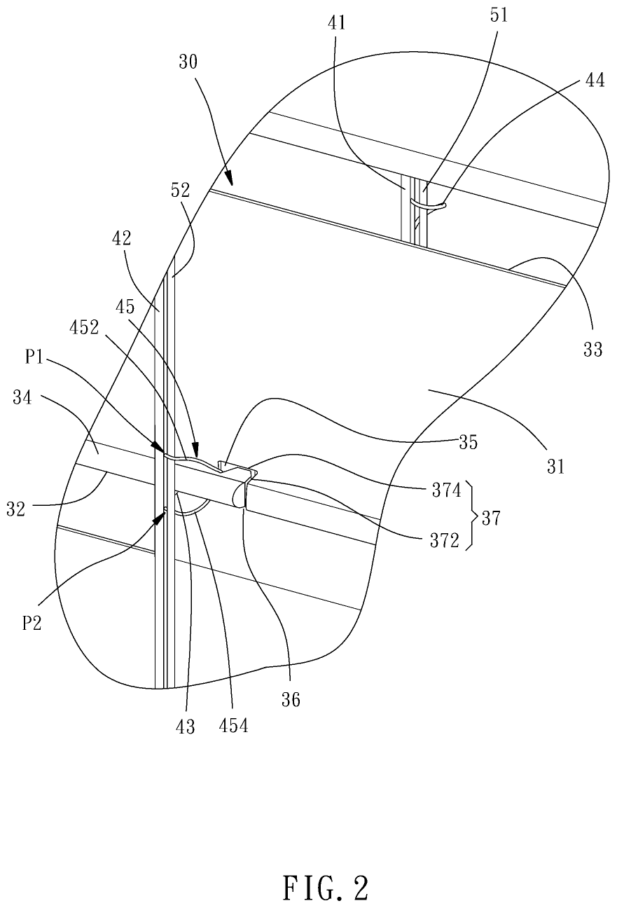

Referring to FIGS. 1 and 2, a venetian blind 10 of a first embodiment of the present invention comprises an upper beam 20, a lower beam 22, a plurality of slats 30, two ladder tapes 40, and two lifting cord assemblies 50.

The upper beam 20 and the lower beam 22 are arranged in an up-down manner.

The slats 30 each have a top surface 31, a bottom surface 32 opposite to the top surface 31, a first edge 33, a second edge 34 opposite to the first edge 33, two through holes 35 through the top and bottom surfaces 31, 32, two openings 36 formed at the second edge 34, and two slots 37 through the top and bottom surfaces 31, 32 and each have a first extending segment 372 extending from the second edge 34 of the slat in a width direction of the slat 30 to the first edge 33 of the slat 30, and a second extending segment 374 perpendicular to the first extending segment 372 and extending from one end of the first extending segment 374 in a length direction of the slat 30 to the through hole 35. The through hole 35 is located between the second edge 34 of the slat 30 and the second extending segment 374 of the slot 30.

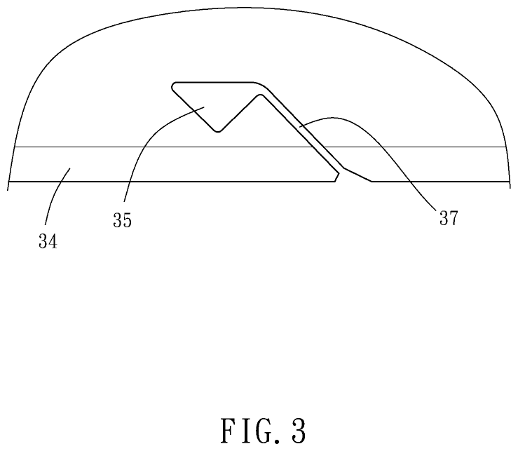

As shown in FIG. 3, it is worth mentioning that the slot 37 can be formed in an inclined manner from the second edge 34 of the slat 30 to the first edge 33 of the slat 30. This can increase the structural strength of the slat 30.

The two ladder tapes 40 are connected between the upper beam 20 and the lower beam 22 and each have a first warp 41, a second warp 42 opposite to the first warp 41, and a plurality of wefts 43 connected between the first and second warps 41, 42 and supporting the bottom surfaces 32 of the slats 30. In this embodiment, the ladder tapes 40 each have a plurality of first ring portions 44 connected with the first warp 41 and a plurality of second ring portions 45 connected with the second warp 42. Further, the second ring portion 45 passes through the through hole 45 through the slot 37 and has an upper segment 452 fixed to the second warp 42 at a first position P1 above the wefts 43 and a lower segment 454 fixed to the second warp 42 at a second position P2 spaced apart from the first position P1 when the slats 40 are in an open state S1 and perpendicular to the second warps 42. The second position P2 can, but not limited to, be located above or below the wefts 43.

The lifting cord assemblies 50 each include a first lifting cord 51 passing through the first ring portions 44 of one of the ladder tapes 40, and a second lifting cord 52 passing through the second ring portions 45 of one of the ladder tapes 40.

It can be seen from the above that through the through holes 35 and the slots 37 of the slats 30, the venetian blind 10 of the present invention allows the ladder tapes to be assembled with the slats 30 conveniently and firmly without using other tools: meanwhile, the damaged slats 30 are easily disassembled from the ladder tapes 40 for repair or replacement. Further, the venetian blind 10 of the present invention prevents the slats 30 from excessive transverse displacement through the second ring portions and the through holes 35, such that the slats 30 can be aligned automatically.

It is worth mentioning that the venetian blind 10 can be changeable in structure according to actual needs.

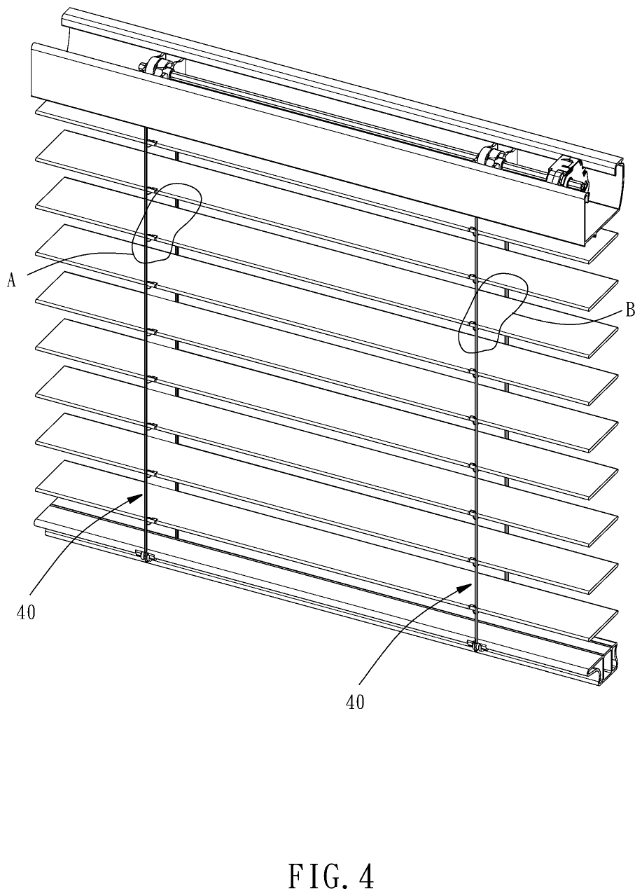

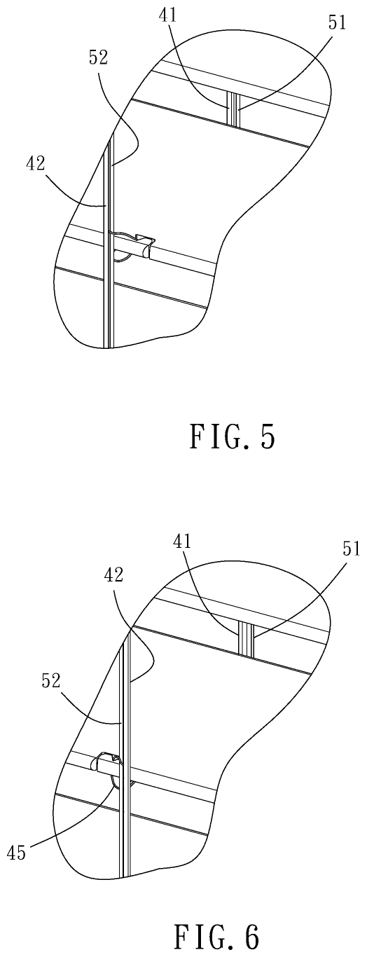

As shown in FIGS. 4 to 6, the first ring portions 44 of the left and right ladder tapes 40 are eliminated; that is, the second lifting cords 52 passes through the second ring portions 45 of the left and right ladder tapes 40, and the first lifting cords 51 are arranged adjacent to the first warp 41 of the left and right ladder tapes 40.

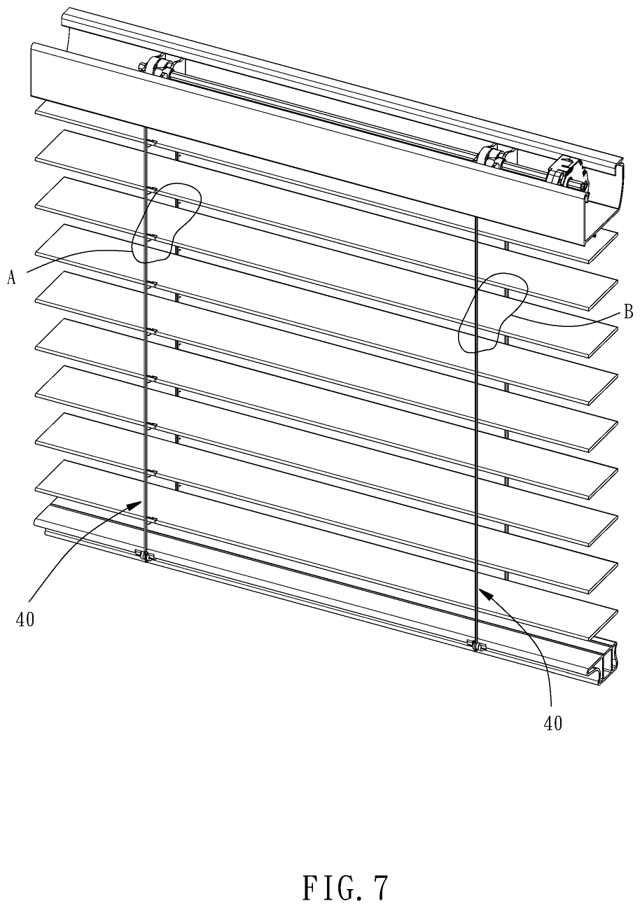

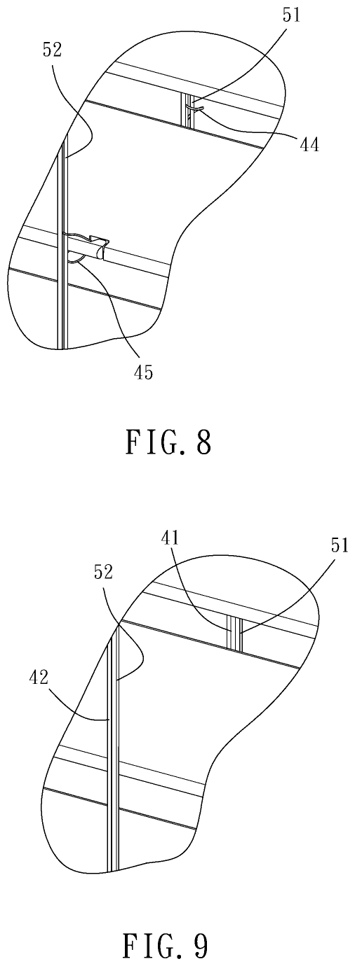

As shown in FIGS. 7 to 9, the first and second ring portions 44, 45 of the right ladder tape 40 are eliminated; that is, the first and second lifting cords 51, 52 of the left the lifting cord assembly 50 pass through the first and second ring portions 44, of the left ladder tape 40, and the first and second lifting cords 51, 52 of the right the lifting cord assembly 50 are arranged adjacent to the first and second warp 41, 42 of the right ladder tape 40. In this embodiment, the slat 30 has one through hole 35 and one slot 37 at one end thereof.

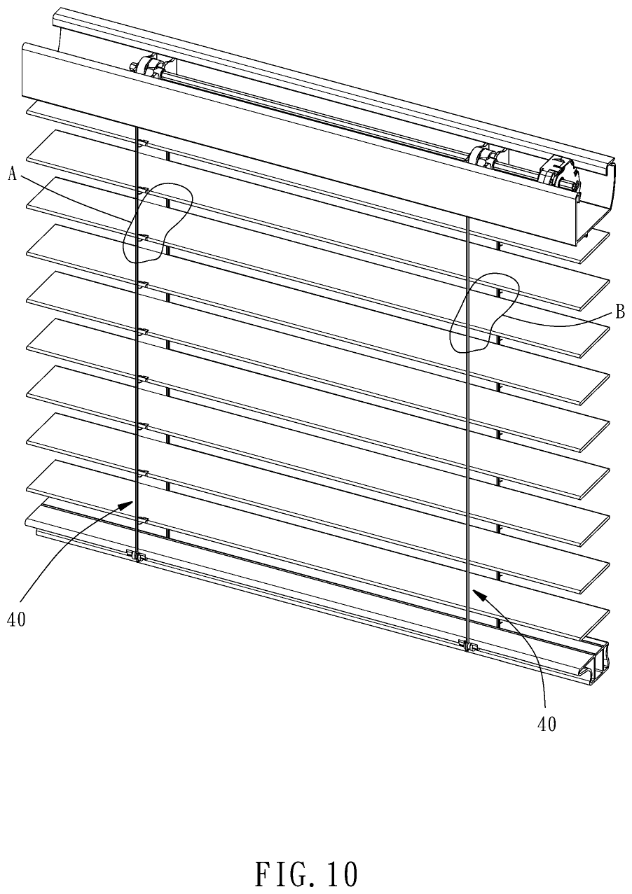

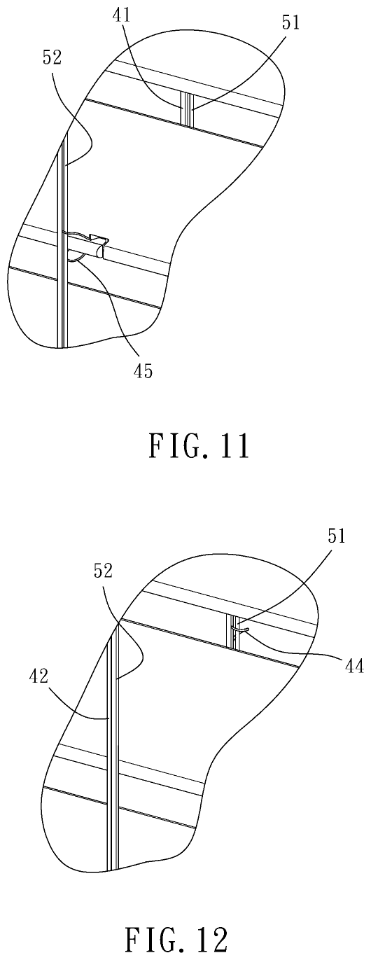

As shown in FIGS. 10 to 12, the first ring portions 44 of the left ladder tape and the second ring portions 45 of the right ladder tape 40 are eliminated; that is, the first lifting cord 51 of the left lifting cord assembly 50 is arranged adjacent to the first warp 41 of the left ladder tapes 40, and the second lifting cord 52 of the left lifting cord assembly 50 passes through the second ring portions 45 of the left ladder tape 40. The first lifting cord 51 of the right lifting cord assembly 50 passes through the first ring portions 44 of the right ladder tapes 40, and the second lifting cord 52 of the right lifting cord assembly 50 is arranged adjacent to the second warp 42 of the right ladder tape 40. In this embodiment, the slat 30 has one through hole 35 and one slot 37 at one end thereof.

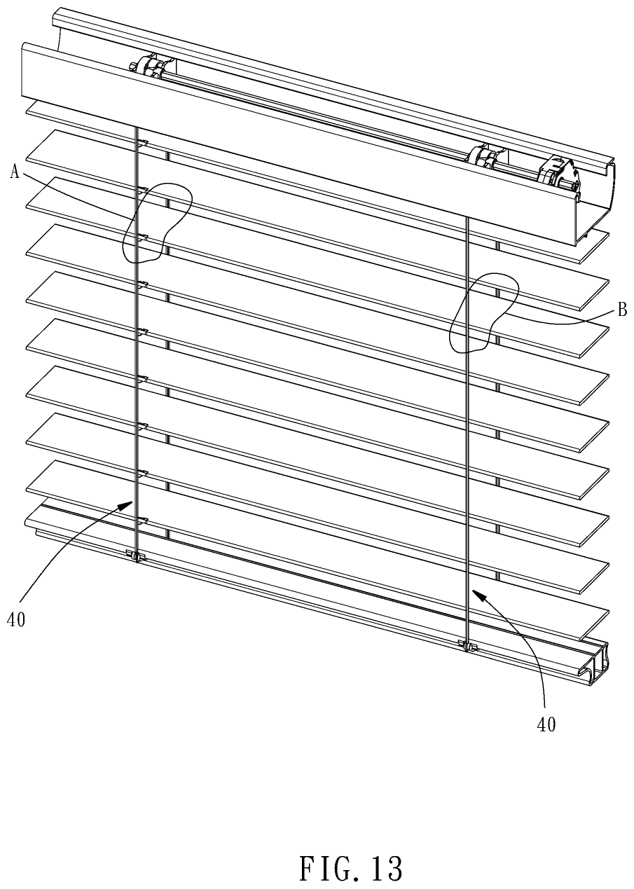

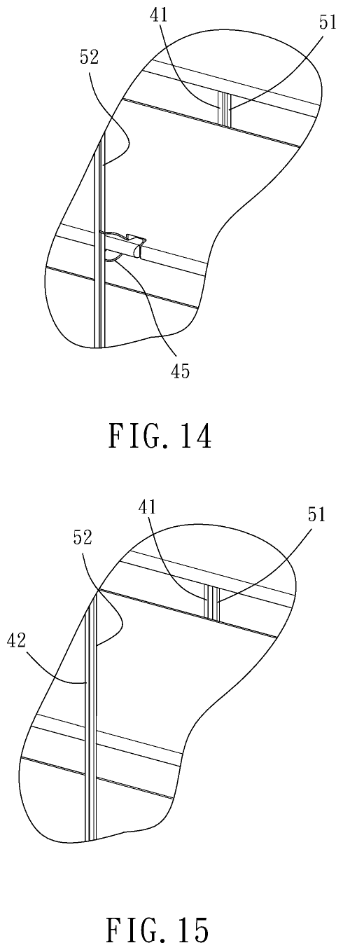

As shown in FIGS. 13 to 15, the first ring portions 44 of the left ladder tape 40, and the first and second ring portions 44, 45 of the right ladder tape 40 are eliminated; that is, the first lifting cord 51 of the left lifting cord assembly 50 is arranged adjacent to the first warp 41 of the left ladder tape 40, and the second lifting cord 52 of the left lifting cord assembly 50 passes through the second ring portions 45 of the left ladder tape 40. The first and second lifting cord 51, 52 of the right lifting cord assembly 50 are arranged adjacent to the first and second warps 41, 42 of the right ladder tape 40. In this embodiment, the slat 30 has one through hole 35 and one slot 37 at one end thereof.

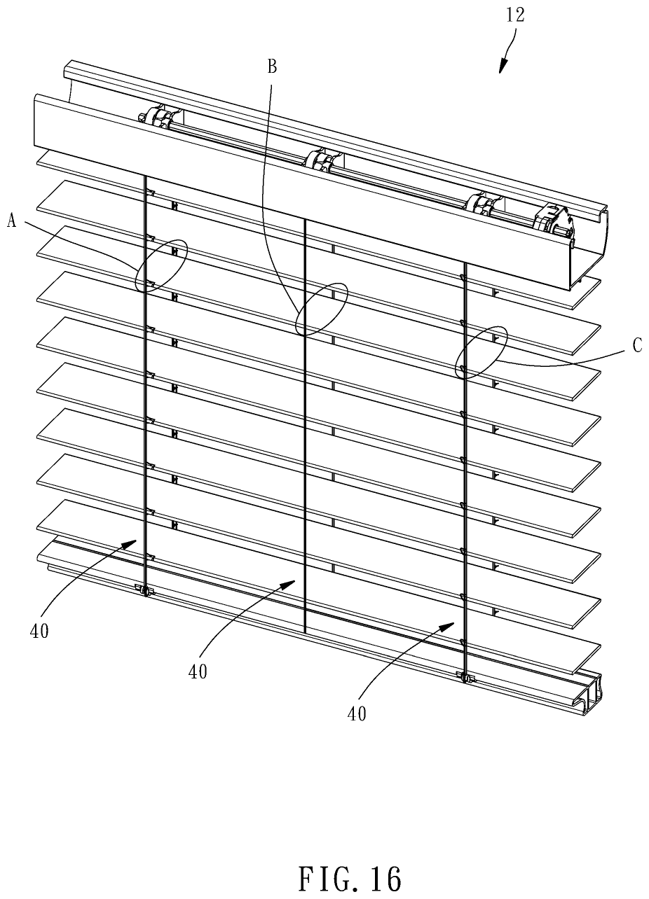

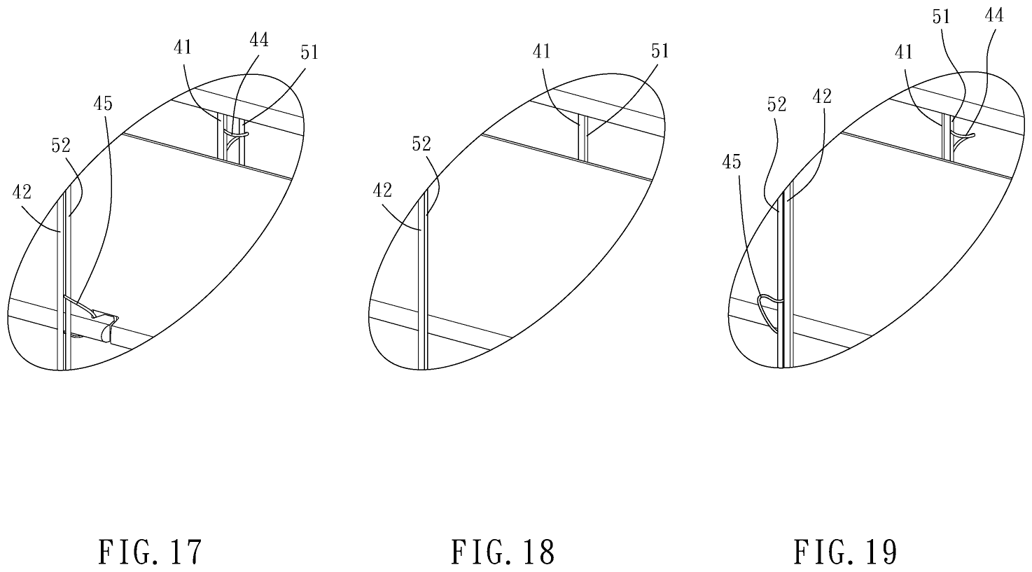

FIG. 16 shows a venetian blind 12 of a sixth embodiment of the present invention that comprises three ladder tapes 40. As shown in FIGS. 17-19, the left and right ladder tapes 40 include the first and second ring portions 44, 45, and the middle ladder tape 40 has no first and second portions 44, 45; alternatively, the second ring portions 45 can be provided at the left and right ladder tapes 40, and the first portions 44 can be provided at the middle ladder tape 40. As such, the venetian blind 12 of the present invention prevents the slats 30 from excessive transverse displacement through the second ring portions 45 and the through holes 35, such that the slats 30 can be aligned automatically.

What is claimed is:

1. A venetian blind comprising:
an upper beam;
a lower beam located below the upper beam;
a plurality of slats arranged between the upper and lower beams, each of the slats having one end thereof provided with a through hole and a slot passing through top and bottom surfaces of the slat and communicating with the through hole;
two ladder tapes connected between the upper and lower beams and each having a first warp, a second warp opposite to the first warp, and a plurality of wefts connected between the first and second warps and supporting the bottom surfaces of the slats, one of the ladder tapes further having a plurality of second ring portions passing through the through holes through the slots; and
a lifting cord assembly including a first lifting cord arranged adjacent to the first warp of one of the ladder tapes, and a second lifting cord arranged adjacent to the second warp of one of the ladder tapes and passing through the second ring portions of one of the ladder tapes.

2. The venetian blind as claimed in claim 1, wherein the ladder tape having the first ring portions further includes a plurality of first ring portions connected with the first warp; the first lifting cord passes through the first ring portions.

3. The venetian blind as claimed in claim 1, further comprising two said lifting cord assemblies; the second lifting cord of one of the lifting cord assemblies passes through the second ring portions of one of the ladder tapes.

4. The venetian blind as claimed in claim 3, wherein the other of the ladder tapes further includes a plurality of first ring portions connected with the first warp; the first lifting cord of the other of the lifting cord assemblies passes through the first ring portions of the other of the ladder tapes.

5. The venetian blind as claimed in claim 1, wherein further comprising two said lifting cord assemblies; each of the slats has two ends thereof each provided with the slot and the through hole; the other of the ladder tapes includes a plurality of the second ring portions; the second lifting cords of the lifting cord assemblies pass through the second ring portions of the ladder tapes.

6. The venetian blind as claimed in claim 1, wherein further comprising two said lifting cord assemblies; the ladder tapes each have a plurality of first ring portions connected with the first warp; the first lifting cords pass through the first ring portions and the second lifting cords pass through the second ring portions.

7. The venetian blind as claimed in claim 1, wherein the slot has a first extending segment extending from a second edge of the slat in a width direction of the slat to a first edge of the slat, and a second extending segment extending from one end of the first extending segment in a length direction of the slat to the through hole, the through hole passing through the top and bottom surfaces of the slat and being located between the second edge of the slat and the second extending segment of the slot.

8. The venetian blind as claimed in claim 7, wherein the second extending segment is perpendicular to the first extending segment.

9. The venetian blind as claimed in claim 1, wherein the slot extends inclinedly from a second edge of the slat to a first edge of the slat.

10. The venetian blind as claimed in claim 1, wherein the second ring portion has an upper segment fixed to the second warp at a first position above the wefts and a lower segment fixed to the second warp at a second position spaced apart from the first position when the slats are in an open state and perpendicular to the second warps.

11. The venetian blind as claimed in claim 10, wherein the second position is located above or below the wefts.
